(19) United States
(12) Patent Application Publication
(10) Pub. No.: US 2014/0139647 A1
(43) Pub. Date: May 22, 2014

(54) STEREOSCOPIC IMAGE DISPLAY DEVICE

(71) Applicant: KABUSHIKI KAISHA TOSHIBA, Tokyo (JP)

(72) Inventor: Hiroyuki NAGATANI, Kanagawa (JP)

(73) Assignee: KABUSHIKI KAISHA TOSHIBA, Tokyo (JP)

(21) Appl. No.: 14/041,866

(22) Filed: Sep. 30, 2013

(30) Foreign Application Priority Data
Nov. 21, 2012 (JP) 2012-255230

(51) Int. Cl. H04N 13/04

(52) U.S. Cl. CPC H04N 13/0468; H04N 13/0425
USPC 348/51

(57) ABSTRACT

According to an embodiment, a stereoscopic image display device includes a display unit, a first obtaining unit, a measuring unit, a determining unit, and a parallax control unit. The display unit displays thereon a stereoscopic image. The first obtaining unit obtains a captured image that is obtained by capturing a space including a viewing position in which a viewer supposed to view the stereoscopic image. The measuring unit measures an angle of convergence of the viewer who appears in the captured image that is obtained by the first obtaining unit. The determining unit determines based on the angle of convergence measured by the measuring unit whether the viewer is fatigued. The parallax control unit performs control to reduce an amount of parallax of the stereoscopic image when the determining unit determines that the viewer is fatigued.

### CROSS-REFERENCE TO RELATED APPLICATION

This application is based upon and claims the benefit of priority from Japanese Patent Application No. 2012-255230, filed on Nov. 21, 2012; the entire contents of which are incorporated herein by reference.

### FIELD

An embodiment described herein relates generally to a stereoscopic image display device.

### BACKGROUND

In recent years, stereoscopic image display devices, what are called three-dimensional displays, that are particularly of the flat panel type and that do not require special glasses have been developed. However, while viewing a stereoscopic image generated by such a three-dimensional display, there can be occurrences of the visually induced motion sickness, or the visual fatigue which does not lead to pathological symptoms, or the asthenopia which does lead to pathological symptoms in some instances.

Conventionally, with the aim of preventing the symptoms such as the visually induced motion sickness from occurring, a technology is known in which the stereoscopic image is controlled using the biological information of the viewer. Moreover, a technology is known in which the pupil diameters of the viewer are obtained using a camera and are referred to while determining the degree of fatigue of the viewer. Then, the contents of pictures or a game are accordingly controlled.

However, in the technology of determining the degree of fatigue by referring to the biological information of the viewer, it is necessary to attach a contact-type sensor to the viewer. That may cause a sense of discomfort to the viewer as well as makes the configuration complex.

Moreover, the pupil diameters of the viewer change according to the contents of the pictures. For that reason, in the technology of determining the degree of fatigue by referring to the pupil diameters of the viewer, the degree of fatigue cannot be determined with sufficient accuracy.

### BRIEF DESCRIPTION OF THE DRAWINGS

FIG. 1 is a conceptual diagram of a stereoscopic image display device according to an embodiment;

FIG. 2 is a diagram illustrating the stereoscopic image display device according to the embodiment;

FIG. 3 is a diagram illustrating a display unit according to the embodiment;

FIG. 4 is a schematic diagram of the display unit according to the embodiment;

FIG. 5 is a diagram illustrating an image processing unit according to the embodiment;

FIG. 6 is a diagram illustrating a calibrating unit according to the embodiment;

FIG. 7 is a diagram illustrating an example of a test image according to the embodiment;

FIG. 8 is a schematic diagram for explaining the relationship between the pop out amount and the amount of parallax of a stereoscopic image according to the embodiment;

FIG. 9 is a flowchart for explaining an example of operations performed in the stereoscopic image display device according to the embodiment;

FIG. 10 is a flowchart for explaining an example of operations performed in the stereoscopic image display device according to the embodiment;

FIG. 11 is a conceptual diagram of a stereoscopic image display device according to a modification example of the embodiment; and

FIG. 12 is a diagram illustrating an example of the test image according to a modification example of the embodiment.

### DETAILED DESCRIPTION

According to an embodiment, a stereoscopic image display device includes a display unit, a first obtaining unit, a measuring unit, a determining unit, and a parallax control unit. The display unit displays thereon a stereoscopic image. The first obtaining unit obtains a captured image that is obtained by capturing a space including a viewing position in which a viewer supposed to view the stereoscopic image. The measuring unit measures an angle of convergence of the viewer who appears in the captured image that is obtained by the first obtaining unit. The determining unit is to determines based on the angle of convergence measured by the measuring unit whether the viewer is fatigued. The parallax control unit performs control to reduce an amount of parallax of the stereoscopic image when the determining unit determines that the viewer is fatigued.

An exemplary embodiment of a stereoscopic image display device is described below in detail with reference to the accompanying drawings. In the stereoscopic image display device according to the embodiment, for example, it is possible to implement a 3D display method such as the integral imaging method (II method) or the multi-view method. Examples of the stereoscopic image display device include a television (TV) set, a personal computer (PC), a smartphone, or a digital photo frame that enables a viewer to view a stereoscopic image with the unaided eye. Meanwhile, a stereoscopic image is an image that includes a plurality of parallax images having mutually different parallaxes. A parallax points to the difference in vision when viewed from a different direction. Meanwhile, in the embodiment, an image can be a still image or a dynamic picture image.

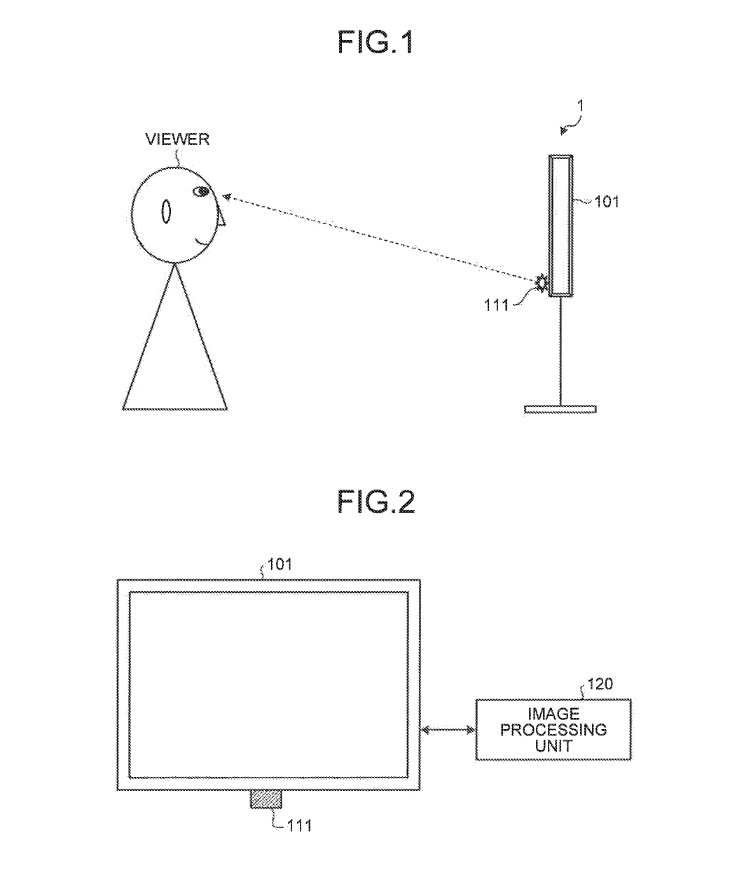

FIG. 1 is a conceptual diagram illustrating a condition in which a viewer is viewing a stereoscopic image that is being displayed on a display unit 101 of a stereoscopic image display device 1 according to the embodiment. FIG. 2 is a diagram illustrating a configuration example of the stereoscopic image display device 1. As illustrated in FIG. 2, the stereoscopic image display device 1 includes a display unit 101, a camera 111, and an image processing unit 120.

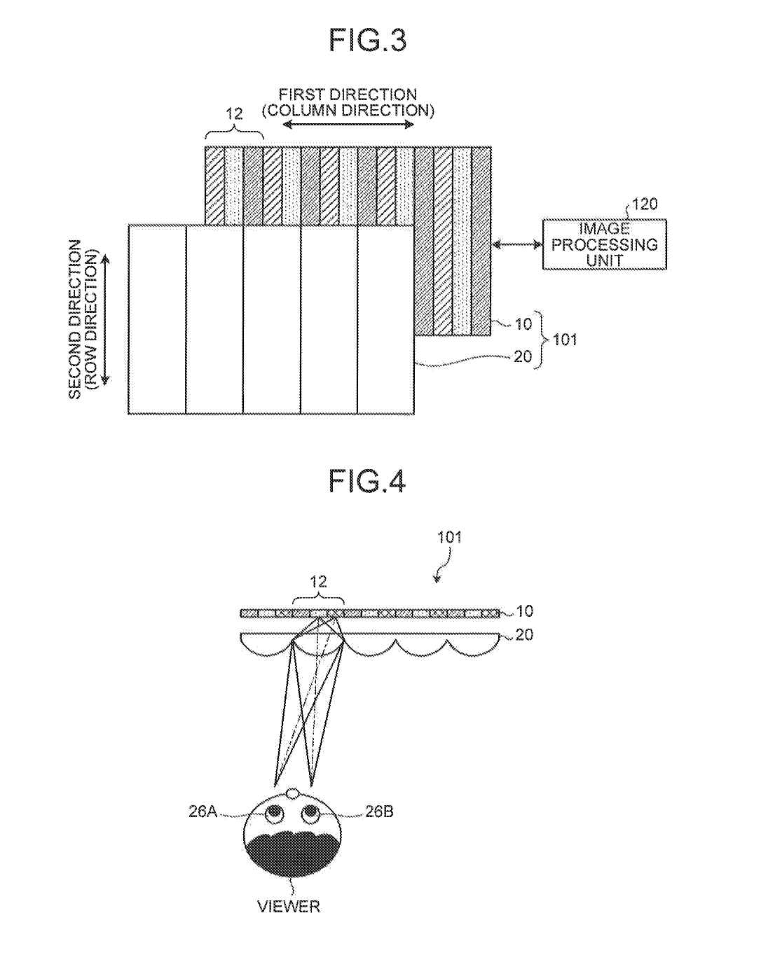

The display unit 101 displays thereon a stereoscopic image. FIG. 3 is a diagram illustrating a configuration example of the display unit 101. As illustrated in FIG. 3, the display unit 101 includes a display panel 10 and a light beam control unit 20. The display panel 10 is a liquid crystal panel in which a plurality of sub-pixels having different color components (such as red (R), green (G), and blue (B) colors) is arranged in a matrix-like manner in a first direction (for example, the row direction (the horizontal direction) with reference to FIG. 3) and a second direction (for example, the column direction (the vertical horizontal direction) with reference to FIG. 3). In this case, a single pixel is made of RGB sub-pixels arranged in the first direction. Alternatively, the arrangement of sub-pixels in the display panel 10 can be any other known arrangement. Moreover, the sub-pixels are not limited to the three colors of red (R), green (G), and blue (B). Alternatively, for example, the sub-pixels can also have four colors.

As the display panel 10, it is possible to use a direct-view-type two-dimensional display such as an organic electro luminescence (organic EL), a liquid crystal display (LCD), a plasma display panel (PDP), or a projection-type display. Moreover, the display panel 10 can also have a configuration including a backlight.

The light beam control unit 20 controls the direction of emission of the light beam that is emitted from each sub-pixel of the display panel 10. Herein, a fixed distance (clearance gap) is maintained between the light beam control unit 20 and the display panel 10. The light beam control unit 20 has a plurality of linearly-extending optical apertures arranged in the first direction for emitting light beams. For example, the light beam control unit 20 can be a lenticular sheet having a plurality of cylindrical lenses arranged thereon or can be a parallax barrier having a plurality of slits arranged thereon.

The optical apertures are arranged corresponding to member images of the display panel 10. Herein, a member image points to a set of parallax images that are displayed in the units of sub-pixels corresponding to the optical apertures. Thus, a member image can be regarded to be an image that includes the pixels of each of a plurality of parallax images. Herein, the set of member images displayed on the display unit 101 constitute a stereoscopic image.

FIG. 4 is a schematic diagram illustrating a condition in which a viewer is viewing the display unit 101. When a plurality of member images 12 is displayed on the display panel 10, the image light beams corresponding to a plurality of parallax directions pass through the optical apertures of the light beam control unit 20. Then, regarding the viewer positioned in the visible area (i.e., the area within which a stereoscopic image can be viewed), different pixels included in the member images 12 (i.e., pixels of different parallax images) are seen to a left eye 26A and different pixels included in the member images 12 (i.e., pixels of different parallax images) are seen to a right eye 26B. In this way, if images having different parallaxes are presented to the left eye 26A and the right eye 26B of the viewer, then it becomes possible for the viewer to stereoscopically view the stereoscopic image being displayed on the display unit 101 (i.e., it becomes possible for the viewer to perform stereoscopic viewing).

Returning to the explanation with reference to FIG. 2; the camera 111 captures images (performs imaging), in a continuous manner, of a predetermined space that includes the viewing position in which the viewer supposed to view a stereoscopic image. The image processing unit 120 authenticates the viewers based on the captured images that are captured by the camera 111. The detailed explanation about the authentication is given later. In the embodiment, the camera 111 is a visible light camera, and the viewer does not become aware of being captured by the camera 111. Moreover, in the embodiment, the camera 111 is embedded in the frame of the housing of the display unit 101 and is further covered by a black and translucent acrylic material. As a result, the viewer does not even become aware of the presence of the camera 111.

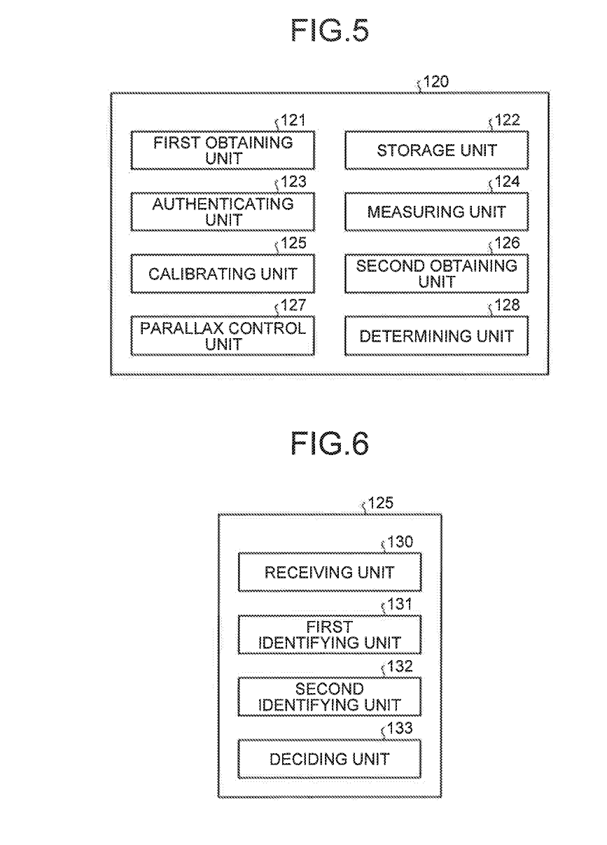

The image processing unit 120 performs control to generate a stereoscopic image and display it on the display unit 101. FIG. 5 is a block diagram illustrating a functional configuration diagram of the image processing unit 120. As illustrated in FIG. 5, the image processing unit 120 includes a first obtaining unit 121, a storage unit 122, an authenticating unit 123, a measuring unit 124, a calibrating unit 125, a second obtaining unit 126, a parallax control unit 127, and a determining unit 128.

The first obtaining unit 121 obtains captured images from the camera 111. In the embodiment, every time a captured image is obtained from the camera 111, the first obtaining unit 121 outputs that captured image to the authenticating unit 123 and the measuring unit 124. The storage unit 122 is used to store, on a viewer-by-viewer basis (for example, for each ID used in identifying a viewer), at least one piece of facial feature information for identifying a face image of that viewer and a critical amount of parallax (described later) in association with each other. Herein, as long as the facial feature information for identifying the face image of the viewer; the facial feature information can indicate, for example, the face image itself or the feature points such as the eyes and the nose of the face.

Every time a captured image is obtained by the first obtaining unit 121, the authenticating unit 123 extracts the face image included in that captured image and determines whether or not one or more pieces of facial feature information registered in the storage unit 122 include the piece of facial feature information for identifying a face image which matches with (or has resemblance to) the extracted face image. If it is determined that one or more pieces of facial feature information registered in the storage unit 122 include the piece of facial feature information for identifying of a face image which matches with the extracted face image (i.e., include the piece of facial feature information for identifying the face image included in the captured image), then the authenticating unit 123 authenticates the viewer corresponding to that facial feature information to be the target viewer for determination performed by the determining unit 128. Then, the authenticating unit 123 outputs the piece of facial feature information for identifying the authenticated viewer, to the measuring unit 124 and the determining unit 128.

On the other hand, if it is determined that one or more pieces of facial feature information registered in the storage unit 122 do not include the piece of facial feature information for identifying the face image included in the captured image, then the authenticating unit 123 notifies the calibrating unit 125 about that fact. The details regarding the calibrating unit 125 are described later.

The measuring unit 124 measures the angle of convergence of the viewer who appears in the captured image that is obtained by the first obtaining unit 121. In the embodiment, from the captured image that is obtained by the first obtaining unit 121, the measuring unit 124 extracts the face image of the viewer that has been authenticated by the authenticating unit 123; and makes use of the extracted face image to measure the angle of convergence of the viewer that has been authenticated by the authenticating unit 123. More particularly, from the extracted face image, the measuring unit 124 detects both eyes of the viewer and measures the angle formed by an approach toward each other by the pupils of the eyes.

Herein, any arbitrary method can be implemented to detect a pupil. As an example, a pupil can be detected by implementing a sclera reflection method in which the boundary between the sclera (equivalent to the white of eye) and the cornea (equivalent to the iris and pupil of eye) is determined from the contrast difference therebetween, and accordingly the position and the orientation is determined. Then, based on the positions of the pupils of both eyes that are detected by means of the sclera reflection method, the measuring unit 124 calculates the angle of convergence that indicates the angle between the gaze directions of the pupils of both eyes. The measuring unit 124 repeats the abovementioned operation in predetermined cycles and outputs information indicating the measurement result (i.e., information indicating the angle of convergence of the authenticated viewer) to the determining unit 128.

The calibrating unit 125 performs a calibration operation for determining the critical amount of parallax, which indicates the amount of parallax of critical level at which the viewer can perform stereoscopic viewing. In the embodiment, if the authenticating unit 123 determines that one or more pieces of facial feature information registered in the storage unit 122 do not include the piece of facial feature information for identifying the face image included in the captured image, then the calibrating unit 125 performs a calibration operation for determining the critical amount of parallax of the unregistered viewer who corresponds to the face image included in the captured image. Then, the calibrating unit 125 registers the critical amount of parallax, which is obtained as a result of the calibration operation, in the storage unit 122 in association with the piece of facial feature information for identifying the face image of the unregistered viewer. As a result, the ID for identifying that viewer, the facial feature information, and the critical amount of parallax is stored in the storage unit 122 in association with each other. When that viewer is authenticated for the first time, then a control amount of parallax indicating the amount of parallax to be controlled by the parallax control unit 127 is registered in association with that viewer. The details of this point are described later. Given below is the explanation of the details of the calibrating unit 125.

FIG. 6 is a block diagram illustrating a detailed functional configuration example of the calibrating unit 125. As illustrated in FIG. 6, the calibrating unit 125 includes a receiving unit 130, a first identifying unit 131, a second identifying unit 132, and a deciding unit 133. The receiving unit 130 receives input of operations of a remote control (not illustrated) that is used during the calibration operation.

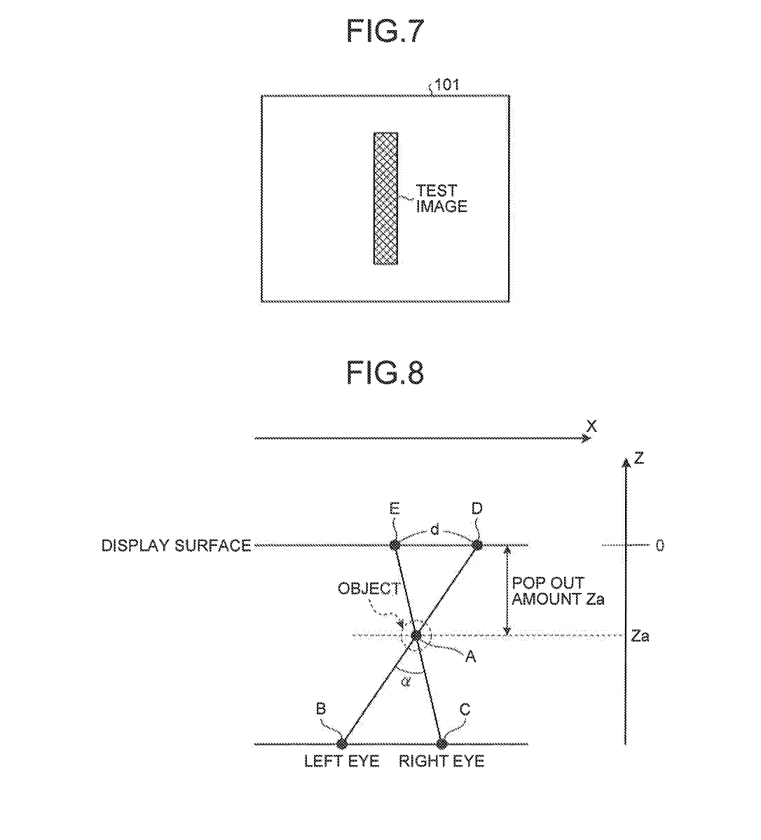

The first identifying unit 131 performs control to vary the amount of parallax of a test image that is used during the measurement and to identify the fusion limit of the viewer that indicates the amount of parallax at which the viewer who is viewing a stereoscopic image cannot perform fusion. More particularly, the first identifying unit 131 performs control in which the amount of parallax of the test image is continually increased; and, as the fusion limit of that viewer, such an amount of parallax of the test image is identified at which the viewer who is viewing the test image cannot perform fusion. In this example, the identification of the fusion limit is performed with respect to the pop out side as well as the depth side. In the embodiment, the first identifying unit 131 performs control to display the test image, which is a vertically long rod-like image as illustrated in FIG. 7, on the display unit 101; and performs control to gradually apply the parallax (gradually increase the amount of parallax) with respect to the 2D display (two-dimensional display) and to output an image or a voice as an instruction to the viewer who is viewing the test image (i.e., the target viewer for calibration) to press a button on the remote control when fusion cannot be performed. While the first identifying unit 131 is performing the control to increase the amount of parallax of the test image; if the receiving unit 130 receives input of a remote control button operation, then the first identifying unit 131 identifies the amount of parallax of the test image at the point of time of receiving the input as the fusion limit.

Moreover, at that time, the measuring unit 124 can extract the face image of the target viewer for calibration from the captured image that is obtained by the first obtaining unit 121; and can repeatedly perform in predetermined cycles the operation of measuring the angle of convergence of the viewer by referring to the extracted face image. Meanwhile, in the case when the difference between the parallactic angle corresponding to the amount of parallax of the test image and the angle of convergence measured by the measuring unit 124 is equal to or greater than a threshold value (i.e., in the case when the position of convergence is clearly out of alignment) or in the case when the behavior of one eye indicates transition to a different position than the other eye; then, regardless of a remote control button operation, the first identifying unit 131 can identify the amount of parallax of the test image at that point of time as the fusion limit.

The second identifying unit 132 performs control to make the viewer (the target viewer for calibration) turn the point of sight in such a way that the angle of convergence goes on increasing, and performs control to identify the convergence near point that indicates the angle of convergence of critical level at which the viewer can bring the eyes closer to each other. In the embodiment, firstly, the second identifying unit 132 performs control to output an image or an audio as an instruction to the viewer to gaze a finger of an extended hand; and then performs control to output an image or an audio as an instruction to the viewer to gradually bring that finger toward the nose. At the same time, the second identifying unit 132 performs control to output an image or an audio as an instruction to the viewer to press a remote control button at the point of time when the finger is seen double.

Moreover, at that time, the measuring unit 124 extracts the face image of the target viewer for calibration from the captured image that is obtained by the first obtaining unit 121; and repeatedly performs in predetermined cycles the operation of measuring the angle of convergence of the viewer by referring to the extracted face image. Meanwhile, if the receiving unit 130 receives input of a remote control button operation, then the second identifying unit 132 can identify the angle of convergence measured by the measuring unit 124 at the point of time of receiving the input as the convergence near point. Moreover, for example, in the case when the behavior of one eye indicates transition to a different position than the other eye; then, regardless of a remote control button operation, the second identifying unit 132 can identify the angle of convergence measured by the measuring unit 124 at that point of time as the convergence near point.

The deciding unit 133 decides on the critical amount of parallax based on the fusion limit identified by the first identifying unit 131 and based on the convergence near point identified by the second identifying unit 132. In the embodiment, the deciding unit 133 decides on the critical amount of parallax to be a value that is equal to or smaller than 80% of the fusion limit identified by the first identifying unit 131 and that corresponds to the parallactic angle at which the largest pop out amount of the stereoscopic image is equal to or smaller than half of the convergence near point identified by the second identifying unit 132. Moreover, for example, as a condition of amount of parallax control, the deciding unit 133 can decide on (set) a condition that the average amount of parallax of a predetermined period of time (such as 10 minutes) is equal to or smaller than half of the fusion limit.

Returning to the explanation with reference to FIG. 5, the second obtaining unit 126 obtains an input image. The parallax control unit 127 controls the amount of parallax of a stereoscopic image in a variable manner. Herein, prior to the authentication performed by the authenticating unit 123, the parallax control unit 127 performs control to generate a stereoscopic image (called a default stereoscopic image) based on an input amount of parallax that indicates the amount of parallax of a predetermined input image, and performs control to display the generated stereoscopic image on the display unit 101. More particularly, for example, the parallax control unit 127 calculates the amount of parallax of each pixel of the input image based on the depth value of each pixel, the position of a predetermined viewpoint (a virtual viewpoint position), and a predetermined pop out amount (or a predetermined depth amount). Then, the parallax control unit 127 shifts each pixel of the input image in the horizontal direction according to the corresponding calculated amount of parallax (the predetermined amount of parallax) to generate a multiview parallax image, and then generates a stereoscopic image based on the multiview parallax image. Meanwhile, the input image can either be a monocular image that is captured by a single camera, or can be stereo images (an image for left eye and an image for right eye) captured by two cameras. Since these aspects represent known technologies, the detailed explanation thereof is not given.

Meanwhile, for example, when a particular viewer is authenticated for the first time by the authenticating unit 123 (for example, authenticated immediately after the calibration operation); the parallax control unit 127 reads the critical amount of parallax corresponding to that viewer from the storage unit 122 and compares the critical amount of parallax that has been read with the input amount of parallax. If the critical amount of parallax is greater than the upper limit of the input amount of parallax; then the parallax control unit 127 registers the upper limit of the input amount of parallax as a control amount of parallax, which indicates the target amount of parallax for control, in the storage unit 122 in association with that viewer. Subsequently, the parallax control unit 127 performs control to generate a stereoscopic image (in this case, the default stereoscopic image) based on the control amount of parallax (the amount of parallax identical to the upper limit of the input amount of parallax) corresponding to the viewer as well as based on the input image, and performs control to display the generated stereoscopic image on the display unit 101.

On the other hand, if the critical amount of parallax is smaller than the upper limit of the input amount of parallax; then the parallax control unit 127 registers the critical amount of parallax as the control amount of parallax in the storage unit 122 in association with that viewer. Then, the parallax control unit 127 performs control to generate a stereoscopic image (in this case, the default stereoscopic image) based on the control amount of parallax (the amount of parallax identical to the critical amount of parallax) corresponding to the viewer as well as based on the input image, and performs control to display the generated stereoscopic image on the display unit 101. Thus, in this case, the amount of parallax of the stereoscopic image that is displayed in the display unit 101 is controlled within the critical amount of parallax of the viewer.

That is, the parallax control unit 127 performs control to generate a stereoscopic image based on the control amount of parallax corresponding to the viewer who has been authenticated by the authenticating unit 123 as well as based on the input image, and performs control to display the generated stereoscopic image on the display unit 101.

Depending on the angle of convergence measured by the measuring unit 124, the determining unit 128 illustrated in FIG. 5 determines whether or not the viewer is fatigued. More particularly, if the difference between the angle of convergence measured by the measuring unit 124 and the parallactic angle corresponding to the amount of parallax of the stereoscopic image is equal to or greater than a first reference value, or if the fluctuation range of fluctuation in the angle of convergence measured by the measuring unit 124 is equal to or greater than a second reference value; then the determining unit 128 determines that the viewer is fatigued. The detailed explanation thereof is given below.

FIG. 8 is a schematic diagram for explaining the relationship between the pop out amount and the amount of parallax of a stereoscopic image. In the example illustrated in FIG. 8, it is assumed that a situation in which the viewer is viewing a display surface of the display unit 101 (i.e., the area on which the images are displayed) is seen from above. In FIG. 8, the z-axis direction represents the depth direction; and the position of z=0 is assumed to be the display surface. Moreover, in FIG. 8, the x-axis direction is orthogonal to the z-axis direction and represents the parallel direction to the display surface. A point B illustrated in FIG. 8 represents the position of the left eye of the viewer (or represents one viewpoint); while a point C illustrated in FIG. 8 represents the position of the right eye of the viewer (or represents a different viewpoint). Furthermore, a point A illustrated in FIG. 8 represents the virtual position of an object that is desirably sensed by the viewer positioned at a pop out position Za. Moreover, a point D illustrated in FIG. 8 represents the display position of the object in the parallax image entering the left eye, while a point E illustrated in FIG. 8 represents the display position of the object in the parallax image entering the right eye. Thus, in the example illustrated in FIG. 8, a length d of a line segment DE corresponds to the amount of parallax.

In the example illustrated in FIG. 8, α represents the parallactic angle corresponding to the amount of parallax d, and Za represents the pop out amount corresponding to the amount of parallax d. Herein, if the viewer is in a normal state (i.e., not in a fatigued state), it is assumed that the angle of convergence of the viewer as measured by the measuring unit 124 is identical to the parallactic angle α. At that time, the left eye and the right eye are looking at the near side of the display surface (looking close), and the accommodation muscles of the eyes become tensed. For that reason, if such a state goes on, then the eyes of the viewer become fatigued and the viewpoint direction of both eyes turns in the direction of relieving the accommodation muscles of the eyes (i.e., the viewer starts looking in the distance). As a result, it can be envisioned that the angle of convergence of the viewer goes on changing to angles that are smaller than α, and it goes on becoming more difficult to view the stereoscopic having the pop out amount Za.

In the embodiment, by focusing on the abovementioned points, when the angle of convergence measured by the measuring unit 124 becomes equal to or smaller than one third of the parallactic angle corresponding to the control amount of parallax (i.e., the upper limit of the amount of parallax of the stereoscopic image) that is associated with the viewer authenticated by the authenticating unit 123, the determining unit 128 determines that the viewer (the authenticated viewer) is fatigued. However, that is not the only possible case, and the first reference value used in determining whether or not the viewer is fatigued can be set to an arbitrary value.

Moreover, in the embodiment, the attention is focused on the fact that when the eyes of the viewer who is viewing a stereoscopic image feel fatigued, then there occurs an increase in the fluctuation range of fluctuation in the angle of convergence of the viewer. Thus, when the fluctuation range of fluctuation in the angle of convergence measured by the measuring unit 124 is equal to or greater than the second reference value, the determining unit 128 determines that the viewer is fatigued. In this example, if the fluctuation range of fluctuation in the pop out amount (or the depth amount) corresponding to the angle of convergence (which can be regarded to be the parallactic angle at that time) measured by the measuring unit 124 is equal to or greater than two thirds of a predetermined pop out amount (such as Za illustrated in FIG. 8, or a predetermined depth amount), and if the fluctuation having frequency between 0.05 Hz to 9 Hz continues for 10 seconds or more; then the determining unit 128 determines that the viewer authenticated by the authenticating unit 123 is fatigued. However, that is not the only possible case. Alternatively, for example, if the variance that indicates the variability in the angle of convergence measured by the measuring unit 124 is equal to or greater than a predetermined threshold value, then the determining unit 128 can determine that the viewer authenticated by the authenticating unit 123 is fatigued. In essence, the second reference value used in determining whether or not the viewer is fatigued can be set to an arbitrary value.

If the determining unit 128 determines that the viewer is fatigued, then the parallax control unit 127 performs control to reduce the amount of parallax of the stereoscopic image. In the embodiment, if the determining unit 128 determines that the viewer authenticated by the authenticating unit 123 is fatigued, then the parallax control unit 127 reduces the control amount of parallax (i.e., the upper limit of the amount of parallax of the stereoscopic image) corresponding to that viewer to two thirds of the present value. That is, the control amount of parallax that is registered in the storage unit 122 and that corresponds to the viewer being considered is updated to two thirds of the present value. However, that is not the only possible case. That is, the amount of reduction in the control amount of parallax can be set in an arbitrary manner. Then, the parallax control unit 127 performs control to generate a stereoscopic image based on the reduced amount of parallax as well as based on the input image, and performs control to display the generated stereoscopic image. Consequently, since the pop out amount (or the depth amount) is kept in check as compared to the previous stereoscopic image, a stereoscopic image with a suppressed 3D effect can be displayed on the display unit 101.

For example, at that time, the parallax control unit 127 can notify the viewer about suppression in the 3D effect by displaying a message such as “Your eyes seem to be fatigued by viewing 3D images. The display from now will have a suppressed 3D effect.” on the display unit 101. Alternatively, for example, the parallax control unit 127 can output the abovementioned message as audio output and notify the viewer about suppression in the 3D effect.

Meanwhile, in the embodiment, if the amount of parallax reduced by the parallax control unit 127 falls below the input amount of parallax by an amount equal to or greater than a third reference value, then the calibrating unit 125 once again performs the calibration operation; and registers the critical amount of parallax, which is obtained as a result of that calibration operation, as the latest control amount of parallax in the storage unit 122 in association with the authenticated viewer. More particularly, if the reduced amount of parallax becomes equal to or smaller than one tenth of the input amount of parallax, then the parallax control unit 127 notifies the calibrating unit 125 about that fact. Upon receiving that notification, the calibrating unit 125 performs control to once again perform the calibration operation for determining the critical amount of parallax of the authenticated viewer and performs control to register the critical amount of parallax, which is obtained as a result of that calibration operation, as the latest control amount of parallax in the storage unit 122 in association with that viewer. Then, the parallax control unit 127 performs control to generate a stereoscopic image based on the latest control amount of parallax (i.e., the critical amount of parallax obtained by once again performing the calibration operation) corresponding to that viewer as well as based on the input image, and performs control to display the generated stereoscopic image on the display unit 101. With that, the stereoscopic image displayed on the display unit 101 has the amount of parallax controlled within the critical amount of parallax that has been obtained by once again performing the calibration operation. Meanwhile, the third reference value used in determining whether or not to once again perform the calibration operation can be set in an arbitrary manner.

In the embodiment, in the case of once again performing the calibration operation with respect to the authenticated viewer; the operation of identifying the convergence near point is not performed, and the deciding unit 133 decides on the fusion limit identified by the first identifying unit 131 as the critical amount of parallax. However, that is not the only possible case. Alternatively, for example, in an identical manner to the calibration operation performed for the first time (i.e., the calibration operation performed prior to authentication); the fusion limit and the convergence near point can be identified, and the critical amount of parallax can be accordingly determined.

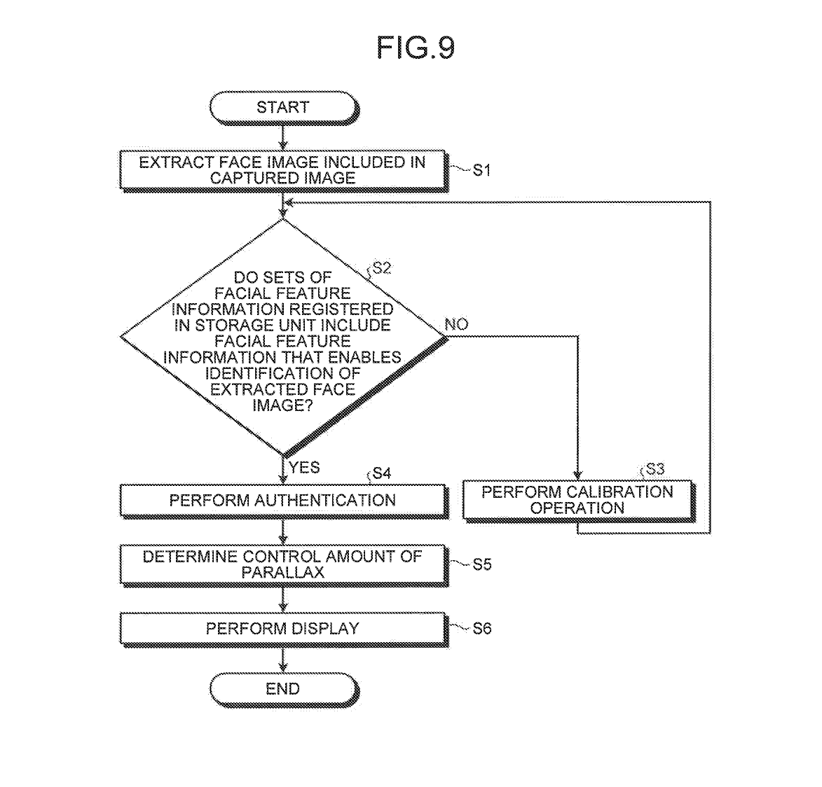

Given below is the explanation of an example of the operations performed in the stereoscopic image display device 1 according to the embodiment. FIG. 9 is a flowchart for explaining an example of the operations performed in the stereoscopic image display device 1 when a particular viewer is authenticated for the first time. In this example, it is assumed that, prior to the authentication performed by the authenticating unit 123, a default stereoscopic image is displayed on the display unit 101 and the control amount of parallax corresponding to that viewer is not stored in the storage unit 122. As illustrated in FIG. 9, firstly, the authenticating unit 123 extracts the face image of the viewer from the captured image that is obtained by the first obtaining unit 121 (Step S1). Then, the authenticating unit 123 determines whether or not one or more pieces of facial feature information registered in the storage unit 122 include the piece of facial feature information for identifying the extracted face image (Step S2).

If it is determined that one or more pieces of facial feature information registered in the storage unit 122 do not include the piece of facial feature information for identifying the extracted face image (No at Step S2), then the authenticating unit 123 notifies the calibrating unit 125 about that fact. Then, the calibrating unit 125 performs the calibration operation (Step S3); and registers the critical amount of parallax, which is obtained as a result of the calibration operation, in the storage unit 122 in association with the piece of facial feature information for identifying the extracted face image (i.e., the face image of an unregistered viewer). As a result, the viewer who corresponds to the face image extracted at Step S1 is authenticated by the authenticating unit 123. In the example illustrated in FIG. 3, after the operation at Step S3 is performed, the operations from Step S2 onward are repeated.

Meanwhile, if it is determined that one or more pieces of facial feature information registered in the storage unit 122 include the piece of facial feature information for identifying the extracted face image (Yes at Step S2), then the authenticating unit 123 authenticates the viewer who corresponds to the piece of facial feature information for identifying the extracted face image to be the target viewer for determination performed by the determining unit 128 (Step S4).

Then, the parallax control unit 127 reads, from the storage unit 122, the critical amount of parallax corresponding to the viewer authenticated by the authenticating unit 123 and determines the control amount of parallax depending on the comparison result of comparison between that critical amount of parallax and the input amount of parallax (Step S5). As described above, if the critical amount of parallax corresponding to the authenticated viewer is greater than the upper limit of the input amount of parallax, then the parallax control unit 127 registers that upper limit of the input amount of parallax as the control amount of parallax in the storage unit 122 in association with that viewer. On the other hand, if the critical amount of parallax is smaller than the upper limit of the input amount of parallax, then the parallax control unit 127 registers that critical amount of parallax as the control amount of parallax in the storage unit 122 in association with that viewer. Subsequently, the parallax control unit 127 performs control to generate a stereoscopic image based on the control amount of parallax corresponding to that viewer as well as based on the input image, and performs control to display the generated stereoscopic image on the display unit 101 (Step S6).

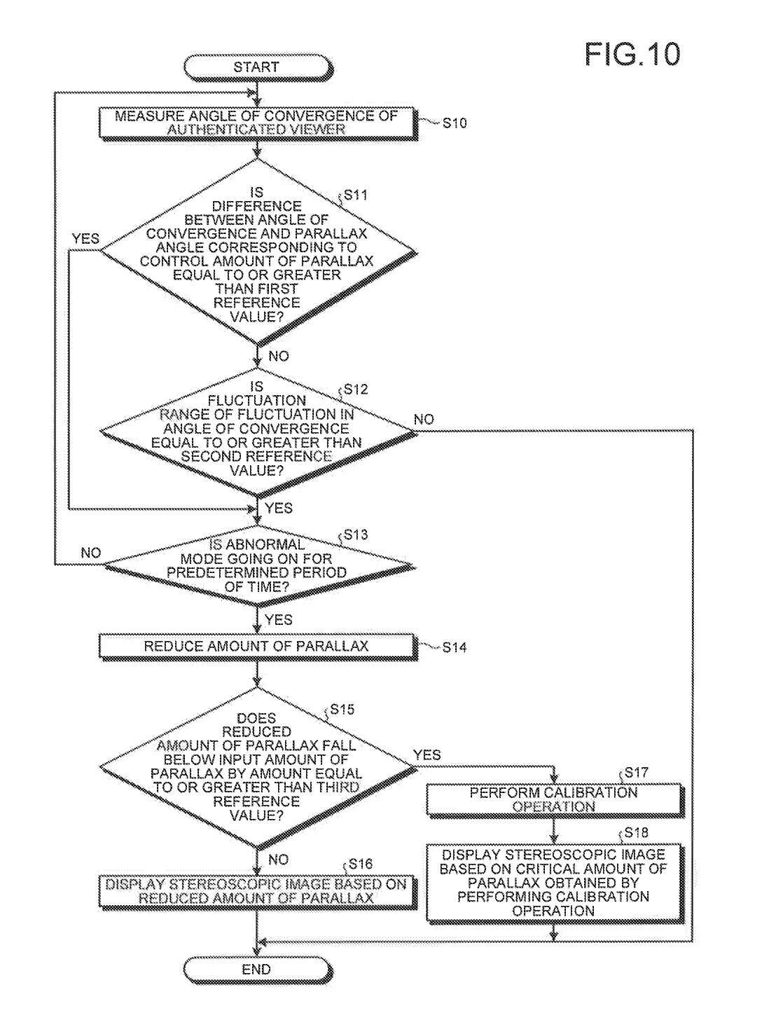

Given below is the explanation of an example of the operations performed in the stereoscopic image display device 1 after a particular viewer is authenticated for the first time. FIG. 10 is a flowchart for explaining an example of the operations performed in the stereoscopic image display device 1 after a particular viewer is authenticated for the first time.

As illustrated in FIG. 10, the measuring unit 124 measures the angle of convergence of the authenticated viewer (Step S10) and outputs information containing the measurement result to the determining unit 128. Then, the determining unit 128 determines whether or not the difference between the angle of convergence measured by the measuring unit 124 and the parallactic angle corresponding to the control amount of parallax associated with the authenticated viewer is equal to or greater than the first reference value (Step S11). As described above, in the embodiment, the determining unit 128 determines whether or not the angle of convergence measured by the measuring unit 124 is equal to or smaller than one third of the parallactic angle corresponding to the control amount of parallax associated with the authenticated viewer.

If it is determined that the difference between the angle of convergence measured by the measuring unit 124 and the parallactic angle corresponding to the control amount of parallax associated with the authenticated viewer is not equal to or greater than the first reference value (No at Step S11), then the determining unit 128 determines whether or not the fluctuation range of fluctuation in the angle of convergence measured by the measuring unit 124 is equal to or greater than the second reference value (Step S12). As described above, in the embodiment, if the fluctuation range (amplitude) in the pop out amount corresponding to the angle of convergence measured by the measuring unit 124 (i.e., the parallactic angle at that time) is equal to or greater than two thirds of a predetermined pop out amount, and if the fluctuation having frequency between 0.05 Hz to 9 Hz continues for 10 seconds or more; then the determining unit 128 determines that the viewer is fatigued.

If it is determined that the fluctuation range of fluctuation in the angle of convergence measured by the measuring unit 124 is not equal to or greater than the second reference value (No at Step S12), then the operations are ended. That is, in this case, it is determined that the authenticated viewer is not fatigued, and thus no control is performed to reduce the control parallax image corresponding to that viewer (i.e., no control is performed to reduce the amount of parallax of the stereoscopic image).

On the other hand, if it is determined that the difference between the angle of convergence measured by the measuring unit 124 and the parallactic angle corresponding to the control amount of parallax associated with the authenticated viewer is equal to or greater than the first reference value (Yes at Step S1), or if it is determined that the fluctuation range of fluctuation in the angle of convergence measured by the measuring unit 124 is equal to or greater than the second reference value (Yes at Step S12); then the determining unit 128 determines that the present condition of the viewer points to an abnormal mode indicating an abnormal condition (in which the user is not normal), and determines whether or not the abnormal mode has been going on for a predetermined period of time (Step S13).

If it is determined that the abnormal mode has not been going on for a predetermined period of time (No at Step S13), then the operations from Step S10 onward are repeated. On the other hand, if it is determined that the abnormal mode has been going on for a predetermined period of time (Yes at Step S13); then the parallax control unit 127 determines that the present condition of the viewer points to a risk mode indicating a risky condition (in which the 3D effect needs to be suppressed), and performs control to reduce the amount of parallax of the stereoscopic image (Step S14). As described above, in the embodiment, the parallax control unit 127 performs control to reduce the control amount of parallax corresponding to the authenticated viewer to two thirds of the present value.

Then, the parallax control unit 127 determines whether or not the reduced amount of parallax falls below the input amount of parallax by an amount equal to or greater than the third reference value (Step S15). As described above, in the embodiment, the parallax control unit 127 determines whether or not the reduced amount of parallax is equal to or smaller than one tenth of the input amount of parallax. If it is determined that the reduced amount of parallax falls below the input amount of parallax not by an amount equal to or greater than the third reference value (No at Step S15), then the parallax control unit 127 performs control to generate a stereoscopic image based on the reduced amount of parallax as well as based on the input image, and performs control to display the generated stereoscopic image (Step S16).

On the other hand, if it is determined that the reduced amount of parallax falls below the input amount of parallax by an amount equal to or greater than the third reference value (Yes at Step S15), then the calibrating unit 125 once again performs the calibration operation (Step S17). As described above, in the embodiment, the calibrating unit 125 performs the calibration operation to determine the critical amount of parallax of the authenticated viewer and registers the critical amount of parallax obtained as a result of that calibration operation as the latest control amount of parallax in the storage unit 122 in association with the authenticated viewer. Then, the parallax control unit 127 performs control to generate a stereoscopic image based on the latest control amount of parallax (i.e., the critical amount of parallax obtained by once again performing the calibration operation) as well as based on the input image, and performs control to display the generated stereoscopic image on the display unit 101 (Step S18).

As explained above, in the embodiment, the angle of convergence is measured for a viewer who appears in a captured image, and whether or not the viewer is fatigued is determined depending on that angle of convergence. Hence, not only there is no need to attach a contact-type sensor to the viewer, but also the determination of whether or not the user is fatigued can be performed without having to depend on the contents of the pictures.

More particularly, in the embodiment, the attention is focused on the following point: if the eyes of the viewer who is performing stereoscopic viewing become fatigued, then the viewpoint direction of both eyes turns in the direction of relieving the accommodation muscles of the eyes (i.e., the viewer starts looking in the distance) or the fluctuation range of fluctuation in the angle of convergence goes on increasing. Hence, if the difference between the angle of convergence of the viewer measured based on the captured image and the parallactic angle corresponding to the amount of parallax of the stereoscopic image (i.e., the parallactic angle corresponding to the control amount of parallax associated with the authenticated user) is equal to or greater than the first reference value, or if the fluctuation range of fluctuation in the angle of convergence measured based on the captured image is equal to or greater than the second reference value; then it is determined that the viewer is fatigued. With that, whether or not a viewer who is viewing a stereoscopic image is fatigued can be determined with high accuracy using a simple configuration.

Moreover, in the embodiment, when it is determined that a viewer who is viewing a stereoscopic image is fatigued, the control amount of parallax corresponding to that user (i.e., the amount of parallax of the stereoscopic image) is reduced and the pop out amount (or the depth amount) is kept in check as compared to the original picture so as to provide a stereoscopic image with a suppressed 3D effect. That is, it becomes possible to provide a picture that does not easily cause fatigued eyes. Thus, according to the embodiment, it becomes possible to provide a stereoscopic image that is suitable to all types of viewers such as the viewers who are comfortable with stereoscopic viewers or the viewers who are not comfortable with stereoscopic viewing (i.e., it becomes possible to provide a stereoscopic image that do not cause viewing fatigue and that provide a realistic sensation).

Meanwhile, the image processing unit 120 according to the embodiment has the hardware configuration that includes a central processing unit (CPU), a read only memory (ROM), a random access memory (RAM), and a communication I/F device. Herein, the functions of each of the abovementioned constituent elements (the first obtaining unit 121, the storage unit 122, the authenticating unit 123, the measuring unit 124, the calibrating unit 125, the second obtaining unit 126, the parallax control unit 127, and the determining unit 128) is implemented when the CPU loads computer programs, which are stored in the ROM, in the RAM and executes those computer programs. However, that is not the only possible case. Alternatively, at least some of the functions of the constituent elements can be implemented using dedicated hardware circuits.

Meanwhile, the computer programs executed in the image processing unit 120 according to the embodiment can be saved as downloadable files on a computer connected to the Internet or can be made available for distribution through a network such as the Internet. Alternatively, the computer programs executed in the image processing unit 120 according to the embodiment can be stored in advance in a nonvolatile memory medium such as a ROM.

While a certain embodiment of the invention has been described, the embodiment has been presented by way of example only, and is not intended to limit the scope of the invention. Indeed, the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

Modifications

Given below is the explanation of modifications of the embodiment.

(1) First Modification

For example, the configuration can be such that the viewer who is watching a stereoscopic image is able to select a 3D expansion mode for the purpose of enhancing the 3D effect. For example, the viewer can operate the remote control to select the 3D expansion mode. In response to the selection of the 3D expansion mode, the parallax control unit 127 can perform control to expand the amount of parallax of the stereoscopic image (i.e., the control amount of parallax corresponding to the viewer) up to 1.5 times of the previous amount of parallax. Meanwhile, the configuration can also be such that, even if the selection of the 3D expansion mode is preceded by the determination that the viewer is in the risk mode as well as preceded by the control to reduce the amount of parallax of the stereoscopic image, the viewer is still allowed to select the 3D expansion mode. However, even after the 3D expansion mode is selected, the operation of controlling the amount of parallax of the stereoscopic image according to the angle of convergence of the authenticated viewer is performed in an identical manner to the embodiment described above.

After the 3D expansion mode is selected; if it is determined that the viewer is in the risk mode, then the configuration can be such that, firstly, the picture is shifted toward the depth side while keeping the same amount of parallax, and then the angle of convergence of the viewer is monitored. For example, with the center of the display surface of the display unit 101 set as the origin (reference point), with the normal direction of the display surface passing through the origin set as the z-axis, with the positive side in the z-axis direction (the near side as compared to the display surface) set as the pop out side, and with the negative side in the z-axis direction (the side beyond the display surface) set as the depth side; the parallax control unit 127 can control the amount of shift while keeping the same amount of parallax so as to ensure that the ratio between the pop out amount and the depth amount becomes 3:7. Even after the picture is shifted to the depth side; if it is determined that the viewer is in the risk mode, then the configuration can be such that the parallax control unit 127 performs control to reset the ratio between the pop out amount and the depth amount to the regular ratio and performs control to reduce the amount of parallax.

In an identical manner, in the embodiment described above too, if it is determined that the viewer is in the risk mode; then the configuration can be such that, prior to reducing the amount of parallax of the stereoscopic image, firstly the picture is shifted to the depth side while keeping the same amount of parallax, and then the angle of convergence of the viewer is monitored.

(2) Second Modification

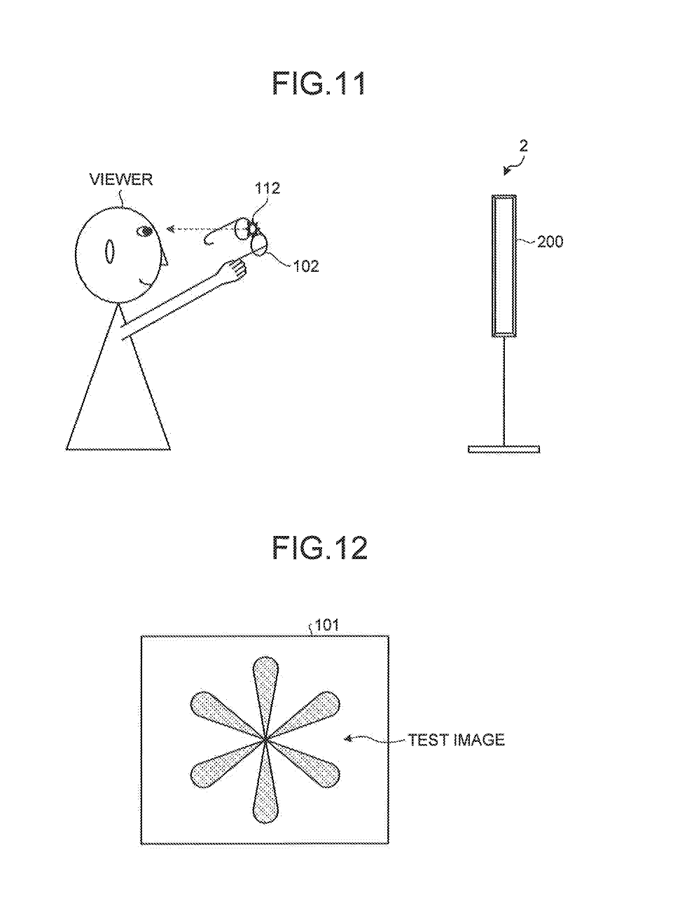

Till now, the explanation was given with reference to a glasses-free stereoscopic image display device. However, that is not the only possible case. Alternatively, for example, the embodiment can also be applied to a glasses-type stereoscopic image display device. FIG. 11 is a conceptual diagram illustrating a condition in which a viewer is viewing a stereoscopic image that is being displayed on a display unit 200 of a glasses-type stereoscopic image display device 2. In this case, in order to accurately measure the angle of convergence of the viewer; for example, it is desirable to have a configuration as illustrated in FIG. 11 in which a camera 112 is installed in the inside portion of the lenses of a pair of eyeglasses 102 (i.e., installed in the portion facing the viewer). That is done because, when the face of the viewer is captured while the viewer is wearing the pair of eyeglasses 102, the reflection of light from the lenses may make it difficult to detect the positions and orientation of the pupils with accuracy.

Moreover, during the calibration operation, the second identifying unit 132 can perform control to instruct the viewer to look at a predetermined position on the pair of eyeglasses 102 with the hand stretched, and then can perform control to instruct the viewer to gradually bring the hand that is holding the pair of eyeglasses 102 toward the face. At the same time, the second identifying unit 132 can perform control to instruct the viewer to press a remote control button at the point of time when the predetermined position (i.e., the pair of eyeglasses 102) is seen double. In this case too, in an identical manner to the embodiment described above, the measuring unit 124 can repeatedly perform the operation of measuring the angle of convergence of the viewer in predetermined cycles. If the receiving unit 130 receives input of a remote control button operation, then the second identifying unit 132 can identify the angle of convergence measured by the measuring unit 124 at the point of time of receiving the input as the convergence near point.

(3) Third Modification

Till now, the explanation was given for an example in which only a single viewer is authenticated. However, that is not the only possible case, and the configuration can be such that a plurality of viewers is authenticated. In this case, the calibration operation can be performed individually with respect to each viewer. Alternatively, for example, by providing a plurality of remote controls, the calibration operations with respect to all viewers can be performed in a simultaneous manner.

For example, in a glasses-type stereoscopic image display, consider a case when a plurality of viewers is authenticated. In that case, from among a plurality of control amounts of parallax that corresponds to the authenticated viewers on a one-to-one basis, the smallest control amount of parallax becomes the target for control performed by the parallax control unit 127. Moreover, for example, in a stereoscopic image display device implementing the II method in which the amount of parallax can be variably controlled according to the area within the visible area in which viewers are positioned, the control amount of parallax corresponding to a viewer present in that area becomes the target for control performed by the parallax control unit 127. For example, if a plurality of authenticated viewers is present in a particular area; then, from among a plurality of control amounts of parallax that corresponds to the authenticated viewers on a one-to-one basis, the smallest control amount of parallax becomes the target for control performed by the parallax control unit 127.

(4) Fourth Modification

For example, consider a case in which an authenticated viewer discontinues viewing of a stereoscopic image and moves to an area out of the capturing range of the camera 111 (i.e., moves away from the viewing position), but returns to the viewing position after the elapse of a predetermined amount of time and starts viewing the stereoscopic image. In that case, the control amount of parallax that is registered immediately prior to the point of time when the viewer moves away from the viewing position (i.e., the control amount of parallax corresponding to the viewer) can be considered to be the target for control performed by the parallax control unit 127. Moreover, the configuration can be such that, for example, the control amount of parallax registered immediately prior to the point of time when the viewer moves away from the viewing position (i.e., the control amount of parallax corresponding to the viewer) can be destroyed either at the point of time when the authenticated viewer moves to an area out of the capturing range of the camera 111 (i.e., at the point of time when the viewer becomes unauthenticated) or after a predetermined amount of time is elapsed since the viewer became unauthenticated. In such a configuration, if the viewer returns to the viewing position, then the parallax control unit 127 performs control to read the critical amount of parallax corresponding to that viewer from the storage unit 122, performs control to determine the control amount of parallax according to the comparison result of comparison between the critical amount of parallax that has been read with the input amount of parallax, and performs control to register that control amount of parallax in the storage unit 122 in association with the authenticated viewer. Thereafter, the subsequent operations are identical to the operations according to the embodiment.

(5) Fifth Modification

In the embodiment described above, the light beam control unit 20 is disposed in such a way that the extending direction of the optical apertures thereof is consistent with the second direction (the column direction) of the display panel 10 (i.e., the configuration of a vertical lens). However, that is not the only possible case. Alternatively, for example, the configuration can be such that the light beam control unit 20 is disposed in such a way that the extending direction of the optical apertures thereof has a predetermined tilt with respect to the second direction (the column direction) of the display panel 10 (i.e., the configuration of a slanted lens).

(6) Sixth Modification

In the embodiment described above, whether or not a viewer is fatigued is determined according to the angle of convergence of that viewer. Alternatively, for example, whether or not a viewer is fatigued can be determined according to the accommodation position (distance of sight) of the eyes of the viewer. If it is determined that the viewer is fatigued, then the control can be performed to reduce the amount of parallax of the stereoscopic image. In this case, regarding a viewer who appears in an image captured using an infrared camera, the responsiveness of the eyes can be measured from the face image of that viewer; and accordingly the accommodation position of the eyes of that viewer can be measured. Then, if the difference between the measured accommodation position and the pop out position (or the depth position) of the stereoscopic image is equal to or greater than a threshold value, then it can be determined that the viewer is fatigued. For example, with respect to the pop out position (or the depth position) that is equivalent to the parallax of the stereoscopic image, if the measured accommodation position is equivalent to twice the parallax or more; then it can be determined that the viewer is fatigued.

Moreover, if the fluctuation range of fluctuation in the measured accommodation position is equal to or greater than a predetermined threshold value, then too it can be determined that the viewer is fatigued. For example, in an identical manner to the case of the angle of convergence, if the fluctuation range of fluctuation in the measure accommodation position is equal to or greater than two thirds of the pop out amount (or the depth amount) of the stereoscopic image, and if the fluctuation having frequency between 0.05 Hz to 9 Hz continues for 10 seconds or more; then too it can be determined that the viewer is fatigued.

(7) Seventh Modification

The abovementioned test image is not limited to a vertically long rod-like image as illustrated in FIG. 7. Alternatively, an image of the “*” symbol illustrated in FIG. 12 can also be used as the test image. In essence, as long as the test image is easy to gaze for the target viewer for calibration, it serves the purpose. Meanwhile, the embodiment and the modifications described herein can be combined in an arbitrary manner.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A stereoscopic image display device comprising:
a display unit to display thereon a stereoscopic image;
a first obtaining unit to obtain a captured image that is obtained by capturing a space including a viewing position in which a viewer supposed to view the stereoscopic image;
a measuring unit to measure an angle of convergence of the viewer who appears in the captured image;
a determining unit to determine based on the angle of convergence measured by the measuring unit whether the viewer is fatigued; and
a parallax control unit to perform control to reduce an amount of parallax of the stereoscopic image when the determining unit determines that the viewer is fatigued.

2. The device according to claim 1, wherein the determining unit determines that the viewer is fatigued when a difference between a parallactic angle corresponding to the amount of parallax of the stereoscopic image and the angle of convergence measured by the measuring unit is equal to or greater than a first reference value.

3. The device according to claim 1, wherein the determining unit determines that the viewer is fatigued when a fluctuation range of fluctuation in the angle of convergence measured by the measuring unit is equal to or greater than a second reference value.

4. The device according to claim 1, further comprising:
a storage unit to store therein a piece of facial feature information and a critical amount of parallax in association with each other for each viewer, the facial feature information for identifying a face image, the critical amount of parallax indicating an amount of parallax of critical level at which the viewer can perform stereoscopic viewing;
an authenticating unit to
extract a face image included in the captured image,
determine whether a piece of facial feature information for identifying the extracted face image is stored in the storage unit, and
authenticate the viewer who corresponds to the piece of facial feature information for identifying the extracted face image as a target for determination performed by the determining unit; and
a calibrating unit to perform a calibration operation for determining the critical amount of parallax.

5. The device according to claim 4, wherein
the calibrating unit performs the calibration operation for determining the critical amount of parallax of the viewer who is unregistered and who corresponds to the face image included in the captured image when the authenticating unit determines that the piece of facial feature information for identifying the extracted face image is not stored in the storage unit.

6. The device according to claim 4, wherein
the calibrating unit stores, in the storage unit, the critical amount of parallax that is obtained as a result of the calibration operation and a piece of facial feature information for identifying the face image of the viewer who is unregistered in association with each other.

7. The device according to claim 4, further comprising a second obtaining unit to obtain an input image, wherein
the parallax control unit stores, in the storage unit, a preset input amount of parallax that indicates an amount of parallax of the input image in association with the viewer, as a control amount of parallax that indicates the amount of parallax to be subject to control when the critical amount of parallax corresponding to the viewer who has been authenticated by the authenticating unit is greater than the input amount of parallax.

8. The device according to claim 7, wherein
the parallax control unit stores, in the storage unit, the critical amount of parallax as the control amount of parallax in association with the viewer when the critical amount of parallax corresponding to the viewer is smaller than the input amount of parallax.

9. The device according to claim 7, wherein the parallax control unit performs control to generate the stereoscopic image based on the control amount of parallax corresponding to the viewer who has been authenticated by the authenticating unit as well as based on the input image, and performs control to display the generated stereoscopic image on the display unit.

10. The device according to claim 4, wherein
the measuring unit extracts a face image of the viewer, who has been authenticated by the authenticating unit, from the captured image and measures the angle of convergence using the extracted face image.

11. The device according to claim 10, wherein
the determining unit determines based on the angle of convergence measured by the measuring unit whether the viewer who has been authenticated by the authenticating unit is fatigued, and
the parallax control unit performs control to reduce the control amount of parallax corresponding to the viewer when the determining unit determines that the viewer who has been authenticated by the authenticating unit is fatigued.

12. The device according to claim 4, wherein, when the reduced amount of parallax falls below the input amount of parallax by an amount equal to or greater than a third reference value, the calibrating unit once again performs the calibration operation and stores, in the storage unit, the critical amount of parallax that is obtained as a result of the calibration operation, in association with the viewer who has been authenticated by the authenticating unit, as a latest control amount of parallax.

13. The display device according to claim 4, wherein the calibration unit includes
a first identifying unit to perform control to vary an amount of parallax of a test image used in measuring a fusion limit to identify the fusion limit of the viewer, the fusion limit indicating an amount of parallax at which the viewer who is viewing the stereoscopic image cannot perform fusion; and
a deciding unit to decide on the critical amount of parallax based on the fusion limit identified by the first identifying unit.

14. The device according to claim 13, wherein the calibration unit includes
a second identifying unit to perform control to identify a convergence near point which indicates an angle of convergence of critical level at which the viewer can bring the eyes closer to each other by making the viewer turn a point of sight so that the angle of convergence goes on increasing; and
the deciding unit to decide on the critical amount of parallax based on the fusion limit identified by the first identifying unit and based on the convergence near point identified by the second identifying unit.

15. The device according to claim 13, wherein the first identifying unit performs control to go on increasing the amount of parallax of the test image to identify, as the fusion limit of the viewer, the amount of parallax of the test image at a point of time when the viewer who is viewing the stereoscopic image cannot perform fusion.

16. An image processing device comprising:
a first obtaining unit to obtain a captured image that is obtained by capturing a space including a viewing position in which a viewer supposed to view a stereoscopic image that is displayed;
a measuring unit to measure an angle of convergence of the viewer who appears in the captured image;
a determining unit to determine based on the angle of convergence measured by the measuring unit whether the viewer is fatigued; and
a parallax control unit to perform control to reduce an amount of parallax of the stereoscopic image when the determining unit determines that the viewer is fatigued.

17. An image processing method comprising:
obtaining a captured image that is obtained by capturing a space including a viewing position in which a viewer supposed to view a stereoscopic image that is displayed;
measuring an angle of convergence of the viewer who appears in the captured image;
determining based on the angle of convergence whether the viewer is fatigued; and
performing control to reduce an amount of parallax of the stereoscopic image when the viewer is fatigued.
